(19) United States
(12) Patent Application Publication
(10) Pub. No.: US 2019/0258451 A1
(43) Pub. Date: Aug. 22, 2019

(54) METHOD AND SYSTEM FOR VOICE ANALYSIS

(71) Applicant: DSP Group Ltd., Herzliya (IL)

(72) Inventor: Michael Gollnick, Wilhermsdorf (DE)

(21) Appl. No.: 16/278,258

(22) Filed: Feb. 18, 2019

Related U.S. Application Data
(60) Provisional application No. 62/632,438, filed on Feb. 20, 2018.

(51) Int. Cl. G06F 3/16; H05B 37/02

(52) U.S. Cl. CPC G06F 3/165; G10L 25/84; H05B 37/0236

(57) ABSTRACT

A method for managing audio level within a space the method may include sensing audio signals from multiple location within the space; calculating an audio parameter associated with a person located in the space; calculating a heat map that comprises areas of different voice levels; selecting, for the person, a selected area out of the areas; wherein the selecting is based on (a) the audio parameter associated with the person, and (b) the different voice levels of the areas; and generating at least one out of an audio signal and a video signal that induces the person to move to the selected area.

### CROSS REFERENCE

This application claims priority from U.S. provisional patent Ser. No. 62/632,438 filing date Feb. 20, 2018.

### BACKGROUND OF THE INVENTION

Loud office environments may be generated due to voice/video meetings or discussions.

Persistence of regular problems and situations at work can create repetitive emotional noisy discussions.

Persons may suffer from high stress level due to the noise.

In addition, noisy environments tend to cause health issues and may increase the stress of some persons.

Noise may also reduce creativity and focus during critical and innovative work phases.

Some persons may be more sensitive to noise than other but they may be located in noisy areas.

There is a growing need to control noise in various environments.

### SUMMARY

There may be provided a method for managing audio level within a space the method may include sensing audio signals from multiple location within the space; calculating an audio parameter associated with a person located in the space; calculating a heat map that may include areas of different voice levels; selecting, for the person, a selected area out of the areas; wherein the selecting may be based on (a) the audio parameter associated with the person, and (b) the different voice levels of the areas; and generating at least one out of an audio signal and a video signal that induces the person to move to the selected area.

The audio parameter may be an audio level generated by the person and wherein the selecting may include selecting an area that has an audio level that best matches the audio level generated by the person.

The audio parameter may be an absence or a presence of a keyword outputted by the person, the keyword may be associated with an audio level, and wherein the selecting may include selecting an area that has an audio level that best matches the audio level generated by the person.

The audio parameter may be an absence or a presence of a keyword outputted by the person, the keyword may be associated with a type of discussion, wherein the selecting may include selecting an area that has an audio level that best matches an audio level mapped to the type of discussion.

The type of discussion may be selected out of a personal discussion and a work related discussion.

The calculating of the heat map may be also based on history of sensed audio signals.

The generating may include illuminating an area associated with a low audio level with a calming ambient light.

The method may include receiving a request from a person to reduce an audio level at a vicinity of the person and requesting at least one person at the vicinity of the person to reduce a level of audio from the person.

There may be provided a non-transitory computer program product for managing audio level within a space the non-transitory computer program product may store instructions for sensing audio signals from multiple location within the space; calculating an audio parameter associated with a person located in the space; calculating a heat map that may include areas of different voice levels; selecting, for the person, a selected area out of the areas; wherein the selecting may be based on (a) the audio parameter associated with the person, and (b) the different voice levels of the areas; and generating at least one out of an audio signal and a video signal that induces the person to move to the selected area.

The audio parameter may be an audio level generated by the person and wherein the selecting may include selecting an area that has an audio level that best matches the audio level generated by the person.

The audio parameter may be an absence or a presence of a keyword outputted by the person, the keyword may be associated with an audio level, and wherein the selecting may include selecting an area that has an audio level that best matches the audio level generated by the person.

The audio parameter may be an absence or a presence of a keyword outputted by the person, the keyword may be associated with a type of discussion, wherein the selecting may include selecting an area that has an audio level that best matches an audio level mapped to the type of discussion.

The type of discussion may be selected out of a personal discussion and a work related discussion.

The calculating of the heat map may be also based on history of sensed audio signals.

The generating may include illuminating an area associated with a low audio level with a calming ambient light.

The non-transitory computer program product may store instructions for receiving a request from a person to reduce an audio level at a vicinity of the person and requesting at least one person at the vicinity of the person to reduce a level of audio from the person.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of an office, various devices, a network and a system;

FIG. 3 illustrates an example of an office, various devices, a network and a system;

FIG. 4 illustrates an example of an office, various devices, a network and a system; and

FIG. 5 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

There may be provided a system, a method, and a non-transitory computer program product for controlling noise.

The system may include devices or may interact with devices that obtain audio signals from different locations. The devices may be fixed, may be mobile, may belong to the office or may belong to a user.

The devices may include, for example, mobile communication devices (such as but not limited to smartphones), teleconference devices, microphones, and the like.

The devices may communicate directly or indirectly with the system using any type of combination of communication links such as wireless links (cellular, ZigbEE, Wi-Fi, and the like), wired links and the like.

The system, alone or in cooperation with one or more devices may be arranged to:
a. Create audio heat map to estimate noisy hot spots.
b. Detect keywords, sentences and use this information to check if discussions are emotionally loaded technical/work related discussions or if they have other reasons. The keywords that characterize the type of discussion may be provided in advance, learnt in real time, and the like.
c. Detect sound volume and energy.
d. Consider time, date to track regular occurrences (e.g. Monday morning) to react upon these events beforehand (e.g. ambient light already set Monday morning)
e. Control these hot spots.
f. Support discussion by inducing persons to move hot spots to loud areas.
g. Induce persons that demand silence to move to quiet areas.
h. Create ambient light to support noise control. Using colors that tend to calm down humans or use light to guide groups to other locations.
i. Use audio effects or music to indicate a too loud environment to noisy hot spots.
j. Use sound masking to create acceptable environment if hot spot cannot be cleared.
k. Change ambient light.
l. Send reminders for nearby loud hotspots (dog bark, voice announcement, ambient light to calm down groups).
m. Guide noisy group hotspot to loud area (based on heatmap or officially loud room)
n. Guide person to quiet area (based on heatmap or to officially quiet room).
o. Receive feedback from persons. For example—the system may detect that an person stated a keyword (“too loud”) or press a predefined key in his communication device—in order to indicate that his environment is too noisy.
p. Using person communication device, or other computer, interrogate person about the noise distortion (loud discussion, ambient noise).

The devices that interact with the system or may belong to the system may include personal devices, office wide devices, cloud services and other smart office devices.

The devices may be controlled by using voice activation and detection technology

A personal device may fulfill the following:
a. Hardware mute for privacy.
b. Voice activation upon user request.
c. User can speak to the device to explain its needs (e.g. “too loud”, “need quite room”).

Office wide devices may fulfill the following:
a. Will only get activated due to requests from personal devices.
b. Does not store information.
c. Create audio heatmaps using voice recognition.
d. Analyze and detect type of noise source using keywords and loudness of noise source.
e. Send information to server which will take a “make or break” decision.

The system (or at least some of the components of the system) may be located in the Cloud—and may activate mechanisms depending on various conditions. The system may use other smart office devices to guide persons/groups or create ambient light/audio.

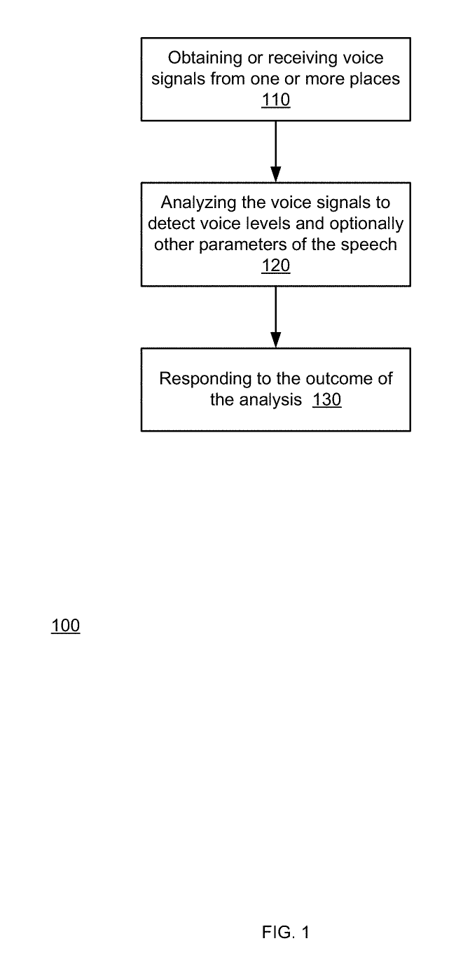

FIG. 1 illustrates an example of method 100.

Method 100 may be executed by a system that is a computerized system. The computerized system may include one or more hardware processors and may include communication modules, memory units, and the like.

Method 100 may start by step 110 of obtaining or receiving voice signals from one or more places.

Step 110 may be followed by step 120 of analyzing the voice signals to detect voice levels and optionally other parameters of the speech.

Step 120 may be followed by step 130 of responding to the outcome of the analysis.

The responding may include various steps such as requesting noisy persons to move a hot spot, changing environmental conditions such as light and/or sound, requesting one or more persons to move to a quieter area, and the like.

Method 100 may also include receiving feedback from an person—such as a gesture, a keyword, an outcome of an interaction between an person and a device (such as pressing a button—or any other man machine interface), and the like.

The allocation of allowable noise values to areas can be done in advance, may change dynamically, and the like.

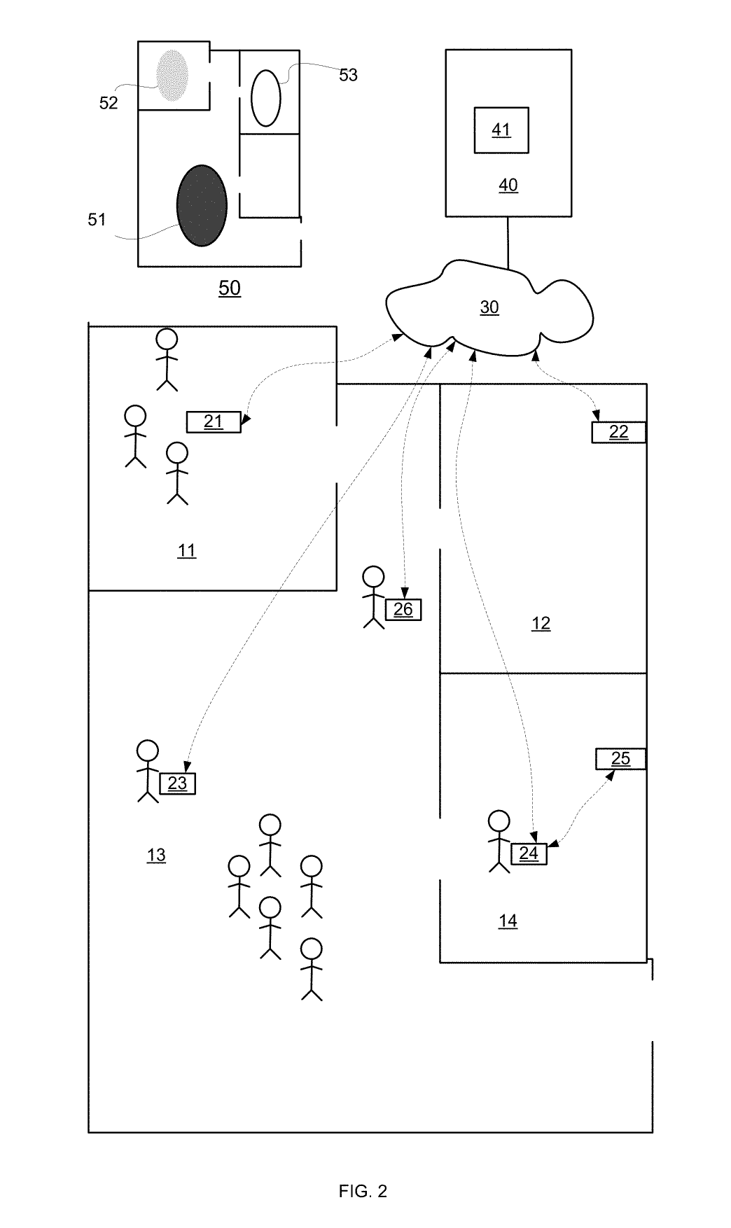

FIG. 2 illustrates an example of an office that includes meeting rooms 11, 12 and 14 and open space 14, various devices, a network and a system.

Meeting room 11 includes a teleconference device 21. Meeting room 12 includes an audio sensing device such as microphone 22. Open space 13 is not equipped with any audio sensing device—but it temporarily includes user device 23 (such as a smartphone) and user device 26—both are capable of sensing audio. Meeting room 14 includes an audio sensing device such as microphone 25 that is wirelessly coupled to user device 24.

Devices such as teleconference device 21, microphone 22, microphone 25 and user devices 23 and 26 are used to sense audio signals in meeting rooms 11, 12 and 14 and open space 13 respectively.

FIG. 2 illustrates computerized system 40 that is coupled via network to various devices 21, 22, 23, 24, and 26.

FIG. 2 also illustrates a heat map 50 generated by system 40—that includes a very noisy area 51 (in open space 13), a partly noisy area 52 (in meeting room 11) and a quiet area 53 (in meeting room 12.

The heat map may be used by system 40 in order to control the environmental conditions, in order to request persons to change their behavior, and the like.

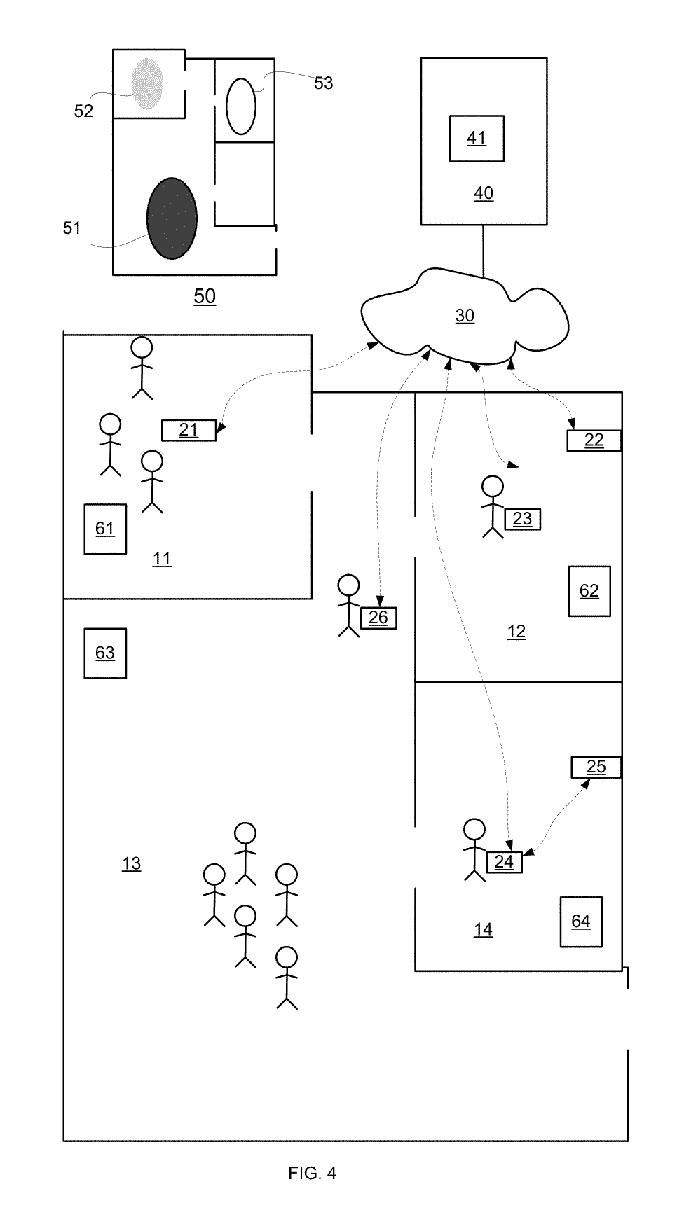

For example, the persons in open space 13 may be requested to lower their voices—and if they do so—the very noisy area 51 becomes a partly noisy area—as illustrated in FIG. 4.

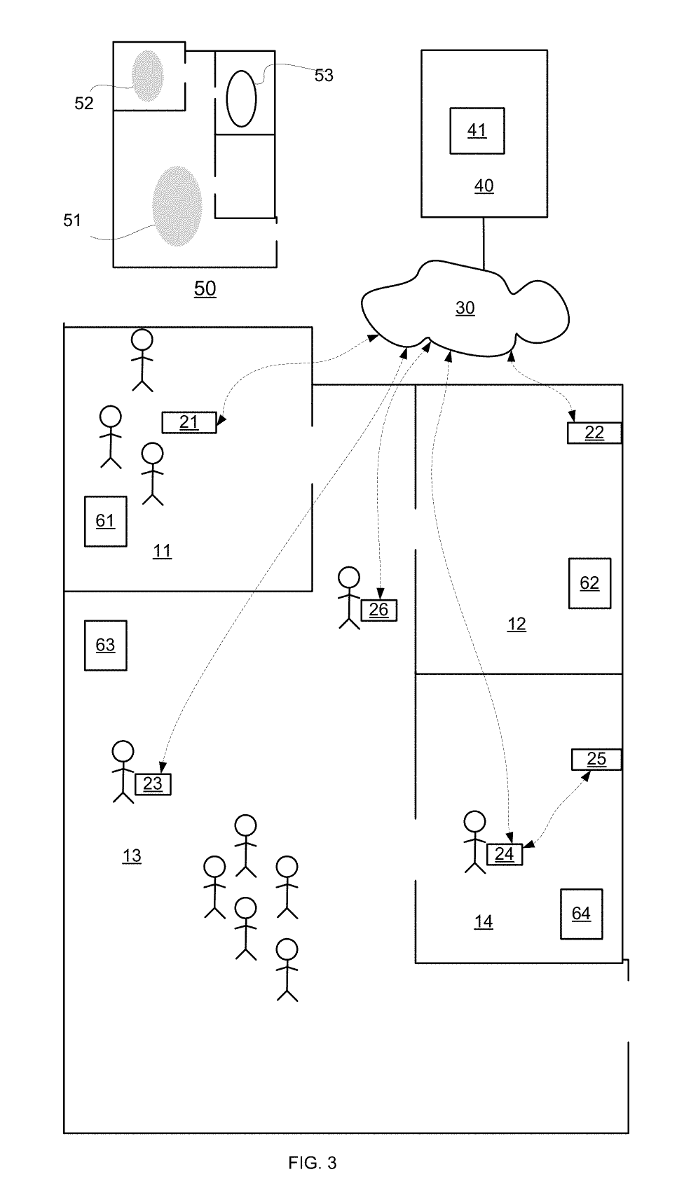

FIG. 3 also illustrates audio and/or visual device 61 (in meeting room 11), audio and/or visual device 62 (in meeting room 12), audio and/or visual device 64 (in meeting room 14), and audio and/or visual device 63 (in open space 13) that may be used for outputting audio and/or visual signals—for example requests aimed to persons, background sound, ambient light, and the like.

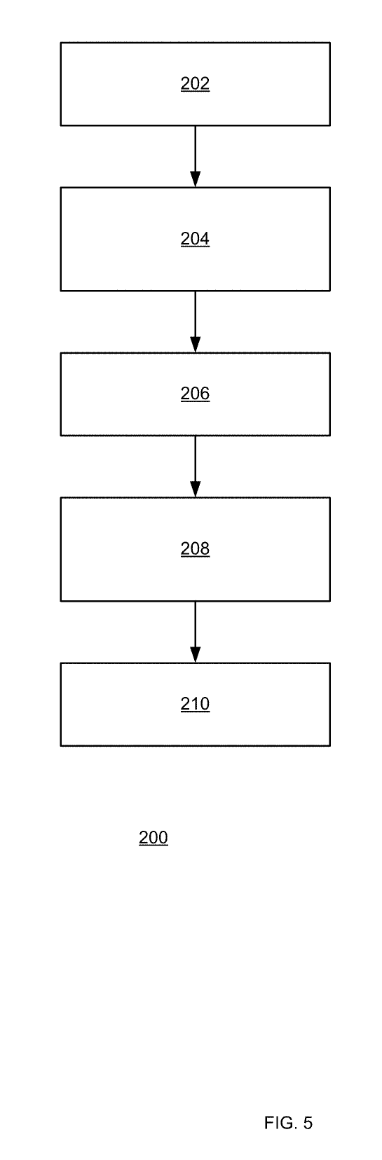

FIG. 5 illustrates method 200 for managing audio level within a space. The space may be an office, one or more rooms, an indoor space or an outdoor space. The space may be of any shape or size but should be large enough to accommodate at least two people.

Method 200 may include step 202 of sensing audio signals from multiple location within the space.

Step 202 may be followed by step 204 of calculating an audio parameter associated with a person located in the space. The audio parameter may be intensity, duration, type of discussion during which the audio signal was generated, and the like.

Step 204 may be followed by step 206 of calculating a heat map that may include areas of different voice levels. The number of voice levels may exceed two. For example—FIG. 2 illustrates a heat map that includes three different types of areas—very noisy area 51, partly noisy area 52 and a quiet area 53. Each area may be associated with a range of audio intensity. The different ranges may be of the same magnitude (difference between maximal and minimal audio signals), or of different magnitudes.

The calculating of the heat map is also based on history of sensed audio signals. For example—if one or more areas of the heat map appear in a periodic manner then the heat map may estimate the future appearance of the area. For example—a loud area may appear each workday at the beginning of the day, at certain hours in the week, and the like. Thus—when generating the heat map this area may appear even slightly before is will re-appear.

Step 206 may be followed by step 208 of selecting, for the person, a selected area out of the areas; wherein the selecting is based on (a) the audio parameter associated with the person, and (b) the different voice levels of the areas.

The selection can be made for one or more person within the space—for all persons or just for some of the persons.

The selection can be made according to any selection rule or rules—for example finding the best matching selected area, finding a matching area, and the like.

The audio parameter may be an audio level generated by the person and step 208 may include selecting an area that has an audio level that best matches the audio level generated by the person.

The audio parameter may be an absence or a presence of a keyword outputted by the person, the keyword is associated with an audio level, and step 208 may include selecting an area that has an audio level that best matches the audio level generated by the person.

For example the key word may indicate that the discussion is person and/or a part of a heated discussion—and thus will be associated with a certain (high) audio level.

The audio parameter may be an absence or a presence of a keyword outputted by the person. The keyword may be associated with a type of discussion. Step 208 may include selecting an area that has an audio level that best matches an audio level mapped to the type of discussion.

The type of discussion may be a personal discussion and a work related discussion.

Step 208 may be followed by step 210 of generating at least one out of an audio signal and a video signal that induces the person to move to the selected area.

Step 210 may include illuminating an area associated with a low audio level with a calming ambient light.

Step 210 may include at least one of the following steps:
a. Controlling a hot spot.
b. Support discussion by inducing persons to move hot spots to loud areas.
c. Induce persons that demand silence to move to quiet areas.
d. Create ambient light to support noise control. Using colors that tend to calm down humans or use light to guide groups to other locations.
e. Use audio effects or music to indicate a too loud environment to noisy hot spots.
f. Use sound masking to create acceptable environment if hot spot cannot be cleared.
g. Change ambient light.
h. Send reminders for nearby loud hotspots (dog bark, voice announcement, ambient light to calm down groups).
i. Guide noisy group hotspot to loud area (based on heatmap or officially loud room)
j. Guide person to quiet area (based on heatmap or to officially quiet room).
k. Using person communication device, or other computer, interrogate person about the noise distortion (loud discussion, ambient noise).

Method 200 may also include receiving a request from a person to reduce an audio level at a vicinity of the person and requesting at least one person at the vicinity of the person to reduce a level of audio from the person.

Method 200 may include updating the heat map based on feedback from users (this area is noisy, this area is quiet).

It should be noted that although some of the example referred to meeting rooms and an office that that invention is applicable to other spaces and other in-door and/or out-door spaces, other locations such as public buildings, public transport or car systems.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner. The integrated circuit may be a system on chip, a general-purpose processor, a signal processor, an FPGA, a neural network integrated circuit, and the like.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for managing audio level within a space the method comprising:
sensing audio signals from multiple location within the space;
calculating an audio parameter associated with a person located in the space ;
calculating a heat map that comprises areas of different voice levels;
selecting, for the person, a selected area out of the areas; wherein the selecting is based on (a) the audio parameter associated with the person, and (b) the different voice levels of the areas; and
generating at least one out of an audio signal and a video signal that induces the person to move to the selected area.

2. The method according to claim 1, wherein the audio parameter is an audio level generated by the person and wherein the selecting comprises selecting an area that has an audio level that best matches the audio level generated by the person.

3. The method according to claim 1, wherein the audio parameter is an absence or a presence of a keyword outputted by the person, the keyword is associated with an audio level, and wherein the selecting comprises selecting an area that has an audio level that best matches the audio level generated by the person.

4. The method according to claim 1, wherein the audio parameter is an absence or a presence of a keyword outputted by the person, the keyword is associated with a type of discussion, wherein the selecting comprises selecting an area that has an audio level that best matches an audio level mapped to the type of discussion.

5. The method according to claim 1 wherein the type of discussion is selected out of a personal discussion and a work related discussion.

6. The method according to claim 1 wherein the calculating of the heat map is also based on history of sensed audio signals.

7. The method according to claim 1 wherein the generating comprises illuminating an area associated with a low audio level with a calming ambient light.

8. The method according to claim 1 comprising receiving a request from a person to reduce an audio level at a vicinity of the person and requesting at least one person at the vicinity of the person to reduce a level of audio from the person.

9. A non-transitory computer program product for managing audio level within a space the non-transitory computer program product that stores instructions for:
sensing audio signals from multiple location within the space;
calculating an audio parameter associated with a person located in the space;
calculating a heat map that comprises areas of different voice levels;
selecting, for the person, a selected area out of the areas; wherein the selecting is based on (a) the audio parameter associated with the person, and (b) the different voice levels of the areas; and
generating at least one out of an audio signal and a video signal that induces the person to move to the selected area.

10. The non-transitory computer program product according to claim 9, wherein the audio parameter is an audio level generated by the person and wherein the selecting comprises selecting an area that has an audio level that best matches the audio level generated by the person.

11. The non-transitory computer program product according to claim 9, wherein the audio parameter is an absence or a presence of a keyword outputted by the person, the keyword is associated with an audio level, and wherein the selecting comprises selecting an area that has an audio level that best matches the audio level generated by the person.

12. The non-transitory computer program product according to claim 9, wherein the audio parameter is an absence or a presence of a keyword outputted by the person, the keyword is associated with a type of discussion, wherein the selecting comprises selecting an area that has an audio level that best matches an audio level mapped to the type of discussion.

13. The non-transitory computer program product according to claim 9 wherein the type of discussion is selected out of a personal discussion and a work related discussion.

14. The non-transitory computer program product according to claim 9 wherein the calculating of the heat map is also based on history of sensed audio signals.

15. The non-transitory computer program product according to claim 9 wherein the generating comprises illuminating an area associated with a low audio level with a calming ambient light.

16. The non-transitory computer program product according to claim 9 that stores instructions for receiving a request from a person to reduce an audio level at a vicinity of the person and requesting at least one person at the vicinity of the person to reduce a level of audio from the person.
